(19) United States
(12) Patent Application Publication
(10) Pub. No.: US 2007/0248365 A1
(43) Pub. Date: Oct. 25, 2007

(54) Methods for moving a media sheet within an image forming device

(75) Inventors: Darin M. Gettelfinger, Lexington, KY (US); John Spicer, Lexington, KY (US); Paul Douglas Horrall, Lexington, KY (US); Christopher Kent Washing, Lexington, KY (US); Franklin Joseph Palumbo, Nicholasville, KY (US); Larry Steven Foster, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/406,579

(22) Filed: Apr. 19, 2006

(51) Int. Cl. G03G 15/00

(52) U.S. Cl. 399/16

(57) ABSTRACT

The present application is directed to methods for determining the location and movement of a media sheet within an image forming device. In one embodiment, the media sheet is positioned within an input area of the device. A pick roller is rotated to move the sheet from the input area and into a media path. An encoder roller may be positioned in contact with the sheet to detect the actual movement of the sheet from the input area. A controller may determine the expected amount of movement based on the movement of the pick roller and compare this amount with an actual amount of movement based on the movement of the encoder roller.

### BACKGROUND

The present application is directed to methods for moving media sheets within an image forming device and, more specifically, to methods for staging and moving the media sheets to prevent print defects.

Image forming devices, such as a color laser printer, facsimile machine, copier, all-in-one device, etc, may include a double transfer system for producing images. Toner is initially transferred from a photoconductive member to an intermediate member at a first transfer location, and then from the intermediate member to the media sheet at a second transfer location. As the toner is being moved towards the second transfer location, a media sheet is moved along a media path to receive the toner image.

The media sheet and toner image should reach the second transfer location at about the same time. If the media sheet arrives before the toner image, the toner image may be transferred to the media sheet at a position that is too low or partially off the bottom of the sheet. Conversely, if the media sheet arrives after the toner image, the toner image may be transferred at a position that is too high or partially off the top of the sheet.

The media path may be configured to allow for increasing and decreasing the speed of the media sheet and thus affect the timing that the media sheet reaches the second transfer location. However, the amount of correction may be limited and large corrections cannot be made. Inherent with this concept is that a shorter media path offers less opportunity for correction. Many image forming devices include short media paths in an effort to reduce the overall size of the device. Therefore, proper timing and media sheet movement is important for these devices as there is limited room for corrections.

### SUMMARY

The present application is directed to methods for determining the location and movement of a media sheet within an image forming device. In one embodiment, the media sheet is positioned within an input area of the device. A pick roller is rotated to move the sheet from the input area and into a media path. An encoder roller may be positioned in contact with the sheet to detect the actual movement of the sheet from the input area. A controller may determine the expected amount of movement based on the movement of the pick roller and compare this amount with an actual amount of movement based on the movement of the encoder roller.

### BRIEF DESCRIPTION OF THE DRAWINGS

FIG. 1 is a schematic view illustrating an image forming apparatus according to one embodiment.

FIG. 2 is a perspective view illustrating an encoder according to one embodiment.

FIG. 3 is a schematic view illustrating a pick mechanism and an encoder according to one embodiment.

FIG. 4 is a perspective view illustrating an encoder according to one embodiment.

FIG. 5 is a schematic view illustrating an image forming apparatus according to one embodiment.

### DETAILED DESCRIPTION

The present application is directed to methods for moving media sheets within an image forming apparatus. One embodiment of the method includes using a pick mechanism for contacting and moving a media sheet from an input area into a media path. An encoder roller is positioned to also contact the media sheets in the input area. A controller senses the movement of the media sheet to determine the location and speed.

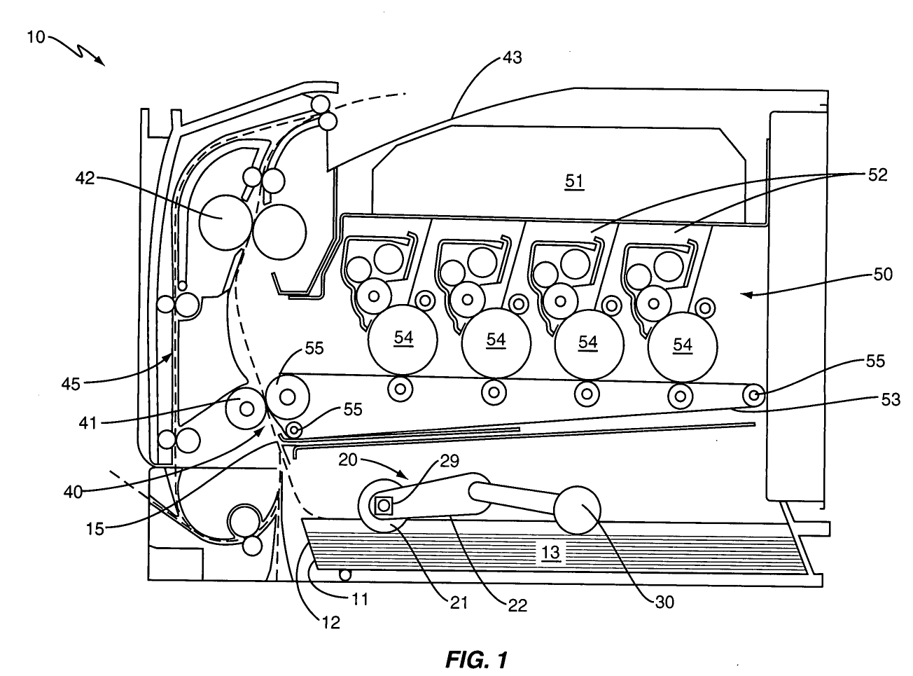

One embodiment of an image forming apparatus is illustrated in FIG. 1. The apparatus 10 includes an input tray 11 including a ramp 12 and being sized to contain a stack of media sheets 13. A pick mechanism 20 is positioned at the input tray 11 for moving a top-most sheet from the stack 13 along the ramp 12 and into a media path 15. Pick mechanism 20 includes an arm 22 and a roller 21. Arm 22 is pivotally mounted to maintain the roller 21 in contact with the top-most sheet of the stack 13. Pick mechanism 20 may include a clutch 29 that affects the movement of the roller 21. In one specific embodiment, clutch 29 is a ball clutch as disclosed in U.S. patent application Ser. No. 10/436,406 entitled “Pick Mechanism and Algorithm for an Image Forming Apparatus” filed on May 12, 2003, and herein incorporated by reference. An encoder 30 is positioned at the input tray 11 to track the movement of the media sheet as will be explained in detail below. The media sheets from the input tray 11 are moved along the media path 15 to a second transfer area 40 where they receive a toner image from an image formation area 50.

The image formation area 50 includes a laser printhead 51, one or more image forming units 52, and a transfer member 53. Laser printhead 51 includes a laser that discharges a surface of photoconductive members 54 within each of the image forming units 52. Toner from a toner reservoir is attracted to the surface area affected by the laser printhead 51. In one embodiment, the toner reservoirs (not illustrated) are independent of the image forming units and can be removed and replaced from the apparatus 10 as necessary. In another embodiment, the toner reservoirs are integral with the image forming units 52. In one embodiment, the apparatus 10 includes four separate image forming units 52 each being substantially the same except for the color of the toner. In one embodiment, the apparatus 10 includes image forming units 52 for use with black, magenta, cyan, and yellow toner.

The transfer member 53 extends continuously around a series of rollers 55. The member 53 receives the toner images from each of the photoconductive members 54 and moves the images to the second transfer area 40 where the toner images are transferred to the media sheet. In one embodiment, the toner images from each of the photoconductive members 54 are placed onto the member 53 in an overlapping arrangement. In one embodiment, a multi-color toner image is formed during a single pass of the transfer member 53. By way of example as viewed in FIG. 1, the yellow toner is placed first on the transfer member 53, followed by cyan, magenta, and black.

The second transfer area 40 includes a nip formed by a second transfer roller 41. A media sheet is moved along the media path 15 through the nip and receives the toner images from the transfer member 53. The media sheet with the toner images next moves through a fuser 42 to adhere the toner images to the media sheet. The media sheet is then either discharged into an output tray 43 or moved into a duplex path 45 for forming a toner image on a second side of the media sheet. Examples of the apparatus 10 include Model Nos. C750 and C752, each available from Lexmark International, Inc. of Lexington, Ky., USA. In another embodiment, the apparatus is a mono printer comprising a single image forming unit 42 for forming toner images in a single color.

In some embodiments as illustrated in FIG. 1, the time necessary to move a media sheet from the input tray 11 to the second transfer area 40 is less than the time to form a toner image on the transfer member 53 and move the toner image to the second transfer area 40. This results in the placement of the toner images on the member 53 before the media sheet is picked from the tray 11. Further, this small distance from the tray 11 to the second transfer area 40 provides little room to correct problems with the timing of the media sheets. Therefore, the media sheets should be picked from the tray 11 in a timely manner and accurately moved along the media path 15.

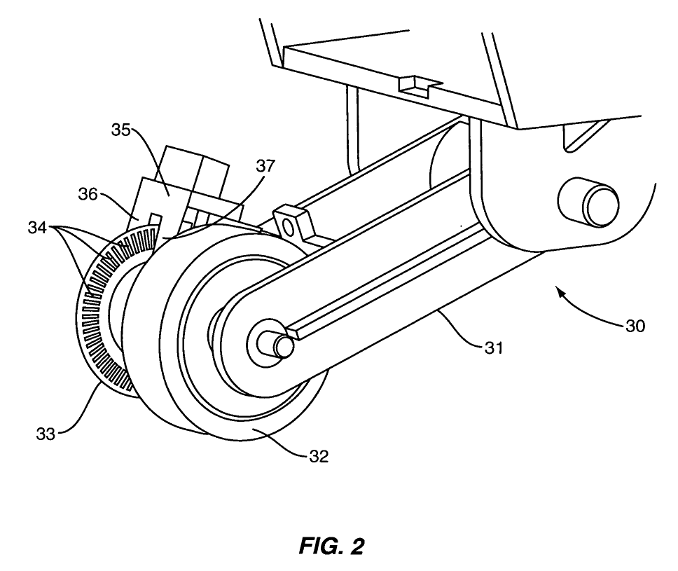

As illustrated in FIGS. 1 and 2, an encoder 30 is positioned at the input tray 11 to determine the position of the media sheet. As best illustrated in FIG. 2, encoder 30 includes an arm 31 that is pivotally attached to a body of the apparatus 10. A roller 32 is positioned towards an end of the arm 31 and remains in contact with a top-most sheet within the stack 13. An encoder wheel 33 is operatively connected to rotate with the roller 32. The encoder wheel 33 includes a plurality of indicators 34, such as apertures or printed lines, spaced along the circumference of the wheel. In one embodiment, each indicator 34 has a substantially rectangular shape and is positioned around a center of the wheel similar to spokes of a wheel. In one embodiment, each indicator 34 is substantially the same size and evenly spaced from the other indicators 34. In another embodiment, indicators 34 have a plurality of different shapes and sizes, and may be located at different positions along the wheel 33.

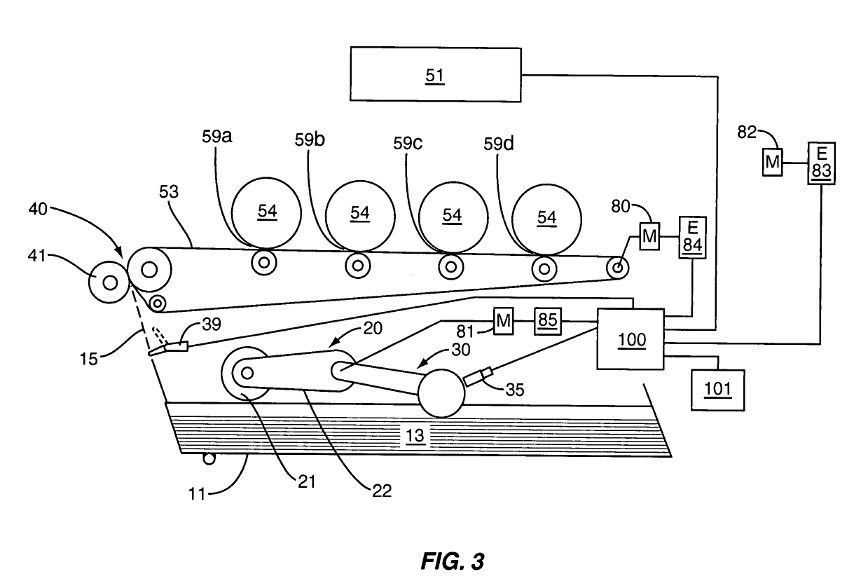

A sensor 35 detects rotational movement of the wheel 33. In one embodiment, sensor 35 includes an emitter 36 and a receiver 37. In one embodiment, emitter 36 emits an optical signal that is detected by the receiver 37. As the wheel 33 rotates, the indicators 34 move past the emitter 36 that cause the signal to pass to the receiver 37. Likewise, the other sections of the wheel 33 move past the emitter 36 and prevent the signal from passing to the receiver 37. A controller 100 (FIG. 3) counts the number of pulses and the frequency of the pulses to determine the speed and location of the media sheet.

The emitter 36 may generate any color or intensity of light. The emitter 36 may generate monochromatic and/or coherent light, such as for example, a gas or solid-state laser. Alternatively, the emitter 36 may emit non-coherent light of any color or mix of colors, such as any of a wide variety of visible-light, infrafred or ultraviolet light emitting diodes (LEDs) or incandescent bulbs. In one embodiment, the emitter 36 generates optical energy in the infrared range, and may include an infrared LED. The receiver 37 may comprise any sensor or device operative to detect optical energy emitted by the emitter 36. In one specific embodiment, the emitter 36 is an infrared LED optical emitter and the receiver 37 is a silicon phototransistor optical detector.

FIG. 3 illustrates one embodiment of the input area and media path 15 that leads to the second transfer area 40. The encoder 30 is positioned within the input area to determine the movement of the media sheets from the media stack 13. A second sensor 39 is positioned along the media path 15 between the input tray 11 and the second transfer area 40. The second sensor 39 determines the exact position of the media sheet as it moves towards the second transfer area 40. A wide variety of media sensors are known in the art. In general, the sensor 39 may comprise an electromechanical contact that is made or broken when a media sheet trips a mechanical lever disposed in the media sheet path; an optical sensor whereby a media sheet blocks, attenuates, or reflects optical energy from an optical source to an optical detector; an opto-mechanical sensor, or other sensor technology, as well known in the art. In one embodiment, the second sensor 39 is positioned about 30 mm upstream from the second transfer area 40.

Controller 100 oversees the timing of the toner images and the media sheets to ensure the two substantially coincide at the second transfer area 40. In one embodiment, controller 100 operates such that the two coincide within +/−0.5 mm. In one embodiment as illustrated in FIG. 3, controller 100 includes a microcontroller with associated memory 101. In one embodiment, controller 100 includes a microprocessor, random access memory, read only memory, and in input/output interface. Controller 100 monitors when the laser printhead 51 begins to place the latent image on the photoconductive members 54, and at what point in time the first line of the toner image is placed onto the transfer member 53. In one embodiment, controller 100 monitors scan data from the laser printhead 51 and the number of revolutions and rotational position of motor 82 that drive the photoconductive members 54. In one embodiment, a single motor 82 drives each of the photoconductive members 54. In one embodiment, two or more motors drive the plurality of photoconductive members 54. In one embodiment, the number of revolutions and rotational position of motor 82 is ascertained by an encoder 83.

In one embodiment, as the first writing line of the toner image is transferred onto the member 53, controller 100 begins to track incrementally the position of the image on member 53 by monitoring the number of revolutions and rotational position of a motor 80 that rotates the member 53. In one embodiment, an encoder 84 ascertains the number of revolutions and rotational position of the motor 80. From the number of rotations and rotational position of the motor 80, the linear movement of member 53 and the image carried thereby can be directly calculated. Since both the location of the toner image on member 53 and the length of member between the transfer nips 59a, 59b, 59c, 59d and second transfer area 40 is known, the distance remaining for the toner images to travel before reaching the second transfer area 40 can also be calculated.

In one embodiment, the position of the image on the member 53 is determined by HSYNCs that occur when the laser printhead 51 makes a complete scan over one of the photoconductive members 54. Controller 100 monitors the number of HSYNCs and can calculate the position of the image. In one embodiment, one of the colors, such as black, is used as the HSYNC reference for determining timing aspects of image movement. The HSYNCs occur at a known periodic rate and the intermediate member surface speed is assumed to be constant.

At some designated time, pick mechanism 20 receives a command from the controller 100 to pick a media sheet. Motor 81 that drives the pick mechanism 20 is activated and the pick roller 21 begins to rotate and move the media sheet from the stack 13 in the input tray 11 into the media path 15. As the media sheet begins to move, the encoder roller 32 and wheel 33 rotate and are detected by the sensor 35. The pick roller 21 continues to rotate and the media sheet moves along the media path 15.

The media sheet moves through the beginning of the media path 15 and eventually trips the media sensor 39. At this point, the controller 100 ascertains the exact location of the leading edge of the media sheet and can incrementally track the continuing position by monitoring the feedback of an encoder 85 associated with pick mechanism motor 81. In one embodiment, because of the short length of the media path 15, pick mechanism 20 moves the media sheet from the input tray 11 and into the second transfer area 40. Therefore, the remaining distance from the media sheet to the second transfer area 40 can be calculated from the known distance between the sensor 39 and second transfer area 40 and feedback from the encoder 85. One embodiment of a feedback system is disclosed in U.S. Pat. No. 6,330,424, assigned to Lexmark International, Inc., and herein incorporated by reference.

The media path 15 can be divided into two separate sections: a first section that extends between the input tray 11 to a point immediately upstream from the sensor 39; and a second section that extends from the sensor 39 to the second transfer area 40. Encoder 30 provides information to the controller 100 when the media sheet is moving through the first section. Information relating to the second section may be obtained from one or more of the sensor 39, motor 81 and encoder 85.

Controller 100 may use feedback from the encoder 85 to correct variations in the media movement through the first section. Controller 100 may be programmed to assume that activation of the motor 81 results in the media sheet being moved a predetermined amount. However, various factors may result in the media sheet advancing through the first section faster or slower than expected. Some variations are corrected during the first section, and other variations are corrected during the second section. In both corrections, pick mechanism 20 is accelerated or decelerated as necessary.

In some embodiments, the media sheet is not moved as fast as expected causing the media sheet to lag behind the expected location. Causes of a lagging media sheet may include the clutch 29 on the pick roller 21 not engaging, slippage between the pick roller 21 and the media sheet, and wear of the pick roller 21. In each instance, the media sheet is behind the expected location. The amount of lag may be detected based on feedback from the encoder sensor 35. Sensor 35 detects the amount of movement of the media sheet that is compared by the controller 100 with the expected amount of movement. Any discrepancy can then be corrected by accelerating the pick mechanism 20 accordingly.

Some variations from the expected position may be corrected in the second section. Examples of these include media stack height uncertainty, and poorly loaded media sheets that are pre-fed up the ramp 12. Because these errors are not caused by the pick mechanism 20, the amount of error is unknown until the leading edge is detected at sensor 39. Once the leading edge is detected, the amount of deviation is determined and the pick mechanism 20 can be accelerated or decelerated as necessary to deliver the media sheet to the second transfer area 40 at the proper time.

Further, feedback from the sensor 39 can be used in combination with the encoder sensor 35 for feeding future media sheets. By way of example, the height of the media stack 13 is unknown when feeding a first sheet. The controller 100 may estimate an expected travel time and activate the pick mechanism 20 at a corresponding time. Once the leading edge reaches the sensor 39, the feedback from encoder sensor 35 can be used to determine the distance the sheet traveled from the stack 13 to the sensor 39 to determine the height of the media stack 13. With this information, controller 100 is able to more accurately predict future pick timings.

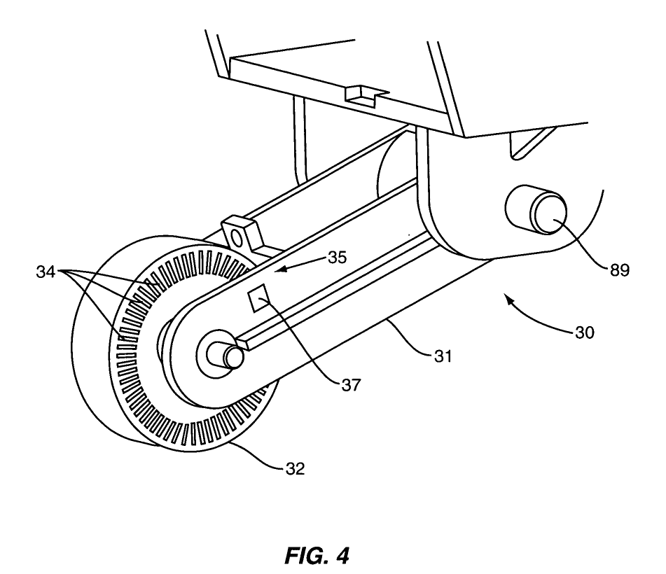

FIG. 4 illustrates another embodiment of the encoder 30. Roller 32 is rotatably mounted on an arm 31. The roller 32 includes a plurality of indicators 34 that move past a sensor 35. The sensor 35 includes an emitter (not illustrated) and a receiver 37. The roller 32 is maintained in contact with the top-most sheet of the media stack 13 as the arm 31 pivots about a point 89. Movement of the top-most media sheet causes the roller 32 to rotate which is detected by the sensor 35.

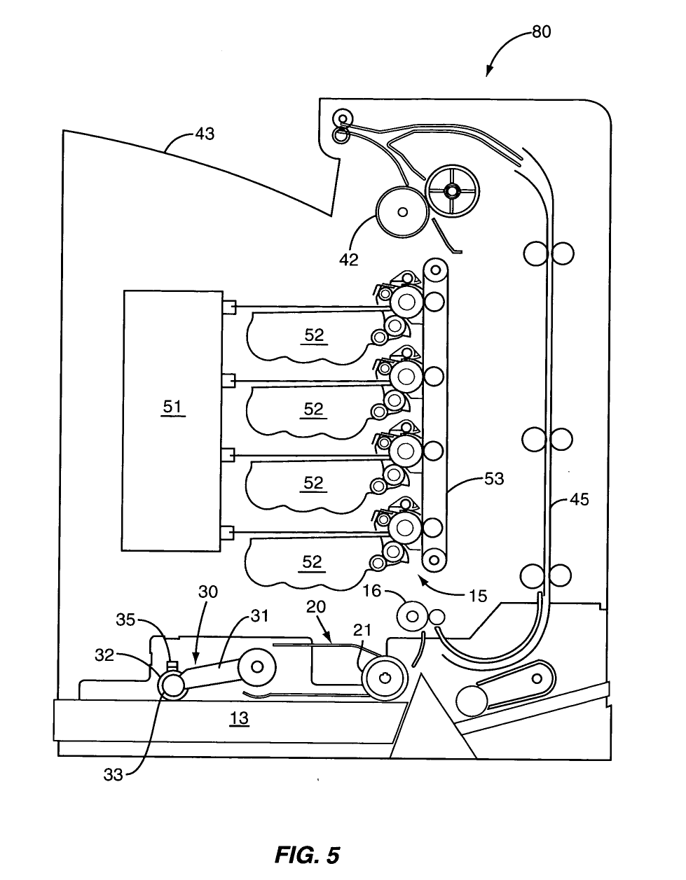

It should be noted that the image-forming apparatus 10 illustrated in the previous embodiments is a two-stage image-forming apparatus. In two-stage transfer apparatus, the toner image is first transferred to a moving transport member 53, such as an endless belt, and then to a print media at the second transfer area 40. However, the present invention is not so limited, and may be employed in single-stage or direct transfer image-forming apparatus 80, such as the image-forming apparatus shown in FIG. 5.

In such apparatus 80, the pick mechanism 20 picks an upper most print media from the media stack 13, and feeds it into the primary paper path 15. Encoder 30 is positioned at the input area and includes an arm 31 including a roller 32 and encoder wheel 33. The roller 32 is positioned on the top-most sheet and movement of the sheet causes the encoder wheel 33 to rotate which is then detected by sensor 35. In one embodiment, media rollers 16 are positioned between the pick mechanism 20 and the first image forming station 52. The media rollers 16 move the media sheet further along the media path 15 towards the image forming stations 52, and may further align the sheet and more accurately control the movement. In one embodiment, the rollers 16 are positioned in proximity to the input area such that the media sheet remains in contact with the encoder 30 as the leading edge moves through the rollers 16. In this embodiment, encoder 30 may monitor the location and movement of the media sheet which can then be used by the controller 100. In another embodiment, the media sheet has moved beyond the encoder 30 prior to the leading edge reaching the rollers 16.

The transport member 53 conveys the media sheet past each image-forming station 52. Toner images from the image forming stations 20 are directly transferred to the media sheet. The transport member 53 continues to convey the print media with toner images thereon to the fuser 42. The media sheet is then either discharged into the output tray 43, or moved into the duplex path 45 for forming a toner image on a second side of the print media.

In one embodiment, the roller 21 of the pick mechanism 20 is mounted on a first arm 22, and the encoder roller 32 is mounted on a second arm 31. In one embodiment, the pick roller 21 is positioned downstream of the encoder roller 32.

The encoder 30 may further be able to detect the trailing edge of the media sheet as it leaves the media stack 13. As the media sheet is moved from the stack 13, the encoder 30 sensed the sheet until the trailing edge moves beyond the roller 32. At this point, the roller 32 stops rotating and a signal may be sent to the controller 100 indicating that the location of the trailing edge. The controller 100 may then begin picking the next media sheet based on the known location of the trailing edge. By knowing this location, the controller 100 does not need to wait for a minimum gap to be formed between the trailing edge and the next sheet. The next sheet may then be picked once the trailing edge is clear and the pick mechanism 20 is ready to pick the next media sheet from the stack 13.

Early picking of a media sheet may have several advantages. First, picking the next media sheet early allows the pick mechanism 20 to tolerate slippage between the pick roller 21 and media sheet, and clutch errors. Second, the staging system may be able to tolerate more error when the media sheet is early because it can eliminate more error by decelerating than by accelerating. Third, if no media sheet movement is detected by the sensor 35, the controller 100 can stop the pick mechanism 20 and reinitiate the pick. Reinitiating may occur prior to the error becoming so large that the staging zones could not remove the error.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

1. A method of determining movement of a media sheet within an image forming device, the method comprising the steps of:
sending a signal to a pick roller in contact with the media sheet to begin rotating and moving the media sheet from an input area and into a media path;
receiving a first feedback indicating rotation of the pick roller;
receiving a second feedback from an encoder in contact with the media sheet in the input area of movement of the media sheet;
rotating the pick roller and moving the media sheet to a sensor located downstream from the input area;
receiving a signal from the sensor indicating the media sheet is at the sensor; and
determining a difference between the first feedback indicating an expected movement of the media sheet from the input area to the sensor with the second feedback indicating an actual movement of the media sheet from the input area to the sensor.

2. The method of claim 1, further comprising moving the media sheet from a top of a media stack within the input area.

3. The method of claim 1, determining a trailing edge location of the media sheet by sensing when the encoder wheel stops rotating.

4. The method of claim 1, further comprising picking a second media sheet from the input area based on a distance determined from moving the media sheet.

5. The method of claim 1, wherein the step of receiving the first feedback indicating rotation of the pick roller comprises receiving pulses from a pick motor encoder that senses a pick motor.

6. The method of claim 1, further comprising adjusting a speed of the pick roller and moving the media sheet along the media path at a different speed after the media sheet reaches the sensor.

7. The method of claim 1, wherein the step of receiving the second feedback from the encoder comprises rotating an encoder roller in contact with the media sheet in the input area and sensing movement of an encoder wheel operatively connected with the encoder roller.

8-14. (canceled)

15. A method of determining movement of a media sheet within an image forming device, the method comprising the steps of:
activating a pick roller in contact with the media sheet to begin rotating and moving the media sheet from an input area;
rotating an encoder roller that is in contact with the media sheet in the input area as the media sheet is moved by the pick roller;
rotating the pick roller and moving the media sheet to a sensor located downstream from the input area;
determining an expected amount of movement of the media sheet based on a first feedback from the pick roller;
determining an actual amount of movement of the media sheet based on a second feedback from the encoder roller; and
determining a variation in movement of the media sheet based on a difference between the expected amount of movement and the actual amount of movement.

16. The method of claim 15, wherein the step of determining the expected amount of movement of the media sheet based on the first feedback from the pick roller comprises determining rotation of the pick tire.

17. The method of claim 15, wherein the step of determining the actual amount of movement of the media sheet based on the second feedback from the encoder roller comprises determining rotation of the encoder roller.

18. The method of claim 15, further comprising determining a location of a trailing edge of the media sheet by detecting when the encoder roller stops rotating.

19. The method of claim 15, further comprising moving the media sheet from a top of a media stack within the input area.

20. The method of claim 15, further comprising causing the pick roller to freely rotate in a forward direction after the media sheet is in control of a faster downstream roller.

21. A device to move media sheets within an image forming apparatus between an input area and a toner transfer area, the device comprising:
a support positioned at the input area to hold a stack of the media sheets;
a pick mechanism positioned at the input area and comprising a pick roller positioned to contact a top-most media sheet on the stack and move the sheet from the stack;
an encoder roller positioned to contact the top-most media sheet on the stack and rotate as the sheet is moved from the stack;
a first sensor to detect movement of the encoder roller to determine movement of the top-most media sheet from the stack;
a media path that extends between the input area and the toner transfer area; and
a second sensor positioned along the media path to detect the top-most sheet as it moves along the media path.

22. The device of claim 21, wherein the pick mechanism is configured to move the media sheet from the input area to the toner transfer area.

23. The device of claim 21, wherein the pick roller is positioned downstream from encoder roller to allow the first sensor to detect a trailing edge of the top-most media sheet as it moves beyond the encoder roller.

24. The device of claim 21, wherein the pick roller is mounted on a first arm and the encoder roller is mounted on a second arm.
